(19) United States
(12) Patent Application Publication
(10) Pub. No.: US 2026/0195876 A1
(43) Pub. Date: Jul. 9, 2026

(54) COGNITIVE COLOR ENHANCEMENT WITH DYNAMIC THREE DIMENSIONAL PERCEPTUAL MODEL BASED ON PSYCHOPHYSICAL PROPERTIES OF HUMAN VISION SYSTEM

(71) Applicant: SAMSUNG ELECTRONICS CO., LTD., Gyeonggi-Do (KR)

(72) Inventors: Chang Su, Foothill Ranch, CA (US); Chenguang Liu, Tustin, CA (US)

(21) Appl. No.: 19/430,049

(22) Filed: Dec. 22, 2025

Related U.S. Application Data
(60) Provisional application No. 63/742,269, filed on Jan. 6, 2025.

(51) Int. Cl. G06T 5/92; G06T 11/10

(52) U.S. Cl. CPC G06T 5/92; G06T 11/10; G06T 2207/10024; G06T 2207/20208

(57) ABSTRACT

Cognitive color enhancement of standard dynamic range (SDR) content for display on a high dynamic (HDR) range panel includes generating scene statics for SDR content to be displayed on a HDR panel. Brightness of pixels of the SDR content is adjusted based on a multi-segment brightness curve generated from audience experience statistics that account for psychophysical effects and viewer perceived visual quality. Saturation of one or more pixels of the SDR content is modified based on sensitivity of hue of the one or more pixels to stimulus. Hue of one or more pixels of the SDR content is shifted to different hues based on the audience experience statistics and the scene statics.

### CROSS-REFERENCE TO RELATED APPLICATIONS

This application claims the benefit of U.S. Application No. 63/742,269 filed on Jan. 6, 2025, which is fully incorporated herein by reference.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to color enhancement of standard dynamic range (SDR) content for playing or rendering on a high dynamic range (HDR) panel.

### BACKGROUND

High dynamic range (HDR) displays typically have a wide-color gamut (WCG) and are capable of displaying HDR content with vibrant colors. HDR panels have gained widespread popularity. HDR content generally refers to content such as multimedia content including, but not limited to, images, animations, and/or video, that captures a dynamic range greater than the dynamic range captured in content generated by a standard dynamic range (SDR) camera sensor. The term “dynamic range” refers to the difference between the lightest light and the darkest dark of an image or frame of HDR content. WCG is generally set forth in ITU Recommendation BT.2020 for high-definition television (UHDTV). Though HDR and WCG refer to different concepts, HDR panels typically are WCG displays.

Despite the growing popularity of HDR panels, e.g., HDR televisions, in the marketplace, the vast majority of content available, e.g., approximately 90%, is SDR content. Unfortunately, simply displaying SDR content on an HDR panel provides a substandard viewing experience for viewers. Often, SDR content displayed on a WCG HDR panel appears visually flattened with hue distortions that arise from the gamut mismatch between the SDR content and the WCG HDR panel. As a result, an HDR panel with the capability to display vivid color will display SDR content with mediocre colors that appear visually flattened and/or that have hue distortions.

There are SDR to HDR automatic mastering techniques available. Existing automatic mastering techniques partly mitigate some issues relating to dynamic range mismatch that occur when displaying SDR content on an HDR panel. These techniques, however, have not been able to provide an adequate solution for addressing the mismatch between the narrow color gamut of SDR content and the WCG of many HDR panels. For example, some available techniques such as simple color-space conversion tend to perform poorly and are unable to effectively enhance colors in the target gamut. Available saturation enhancement techniques lack the ability to project colors between different color gamuts and, as such, may produce visible hue distortions. Available color gamut boundary stretching techniques often produce unnatural colors because the color expansion performed does not account for, or match, the non-linear properties of the Human Vision System (HVS). Available auto-mastering techniques also do not account for other cognitive factors such as the sensitivity of the HVS to skin-tone.

Given the large amount of SDR content available and the issues relating to displaying such content on WCG HDR panels, the ability to play SDR content on WCG HDR panels while maintaining high visual quality has become a significant goal. This ability, however, still remains a challenge.

### SUMMARY

In some examples, a method includes generating scene statics for standard dynamic range (SDR) content to be displayed on a high dynamic range panel. The method includes adjusting brightness of pixels of the SDR content based on a multi-segment brightness curve generated from audience experience statistics that account for psychophysical effects and viewer perceived visual quality. The method includes modifying saturation of one or more pixels of the SDR content based on sensitivity of hue of the one or more pixels to stimulus. The method includes shifting hue of one or more pixels of the SDR content to different hues based on the audience experience statistics and the scene statics.

The foregoing and other implementations can each optionally include one or more of the following features, alone or in combination. Some example implementations include all the following features in combination.

In some aspects, adjusting the brightness of pixels based on the multi-segment brightness curve includes decreasing brightness of pixels of the SDR content in a low tone dynamic range, increasing brightness of pixels of the SDR content in a middle tone dynamic range, and increasing perceptual contrast of pixels of the SDR content in a high tone dynamic range.

In some aspects, modifying saturation and shifting hue are performed based on psychophysical effects of the human vision system using one or more logistic curves that provide visual smoothness.

In some aspects, modifying saturation includes increasing saturation of one or more pixels of a first hue having a first sensitivity to stimulus using a first weight and increasing saturation of one or more pixels of a second hue having a second sensitivity to stimulus that is less than the first sensitivity using a second weight that exceeds the first weight. In some aspects, the first hue is at least one of blue or red and the second hue is green.

In some aspects, shifting hue of one or more pixels of the SDR content includes shifting one or more pixels of a first selected hue to a second selected hue based on the audience experience statistics and psychophysical effects of the human vision system. In some aspects, shifting one or more pixels of the first hue to the second hue include at least one of shifting one or more pixels of cyan to blue, shifting one or more pixels of yellow-green to green, shifting one or more pixels of orange or orange-red to red, shifting one or more pixels of purple or purple-red to red. In some aspects, the one or more pixels are shifted based on a hue shift function including a lower hue shift function and an upper hue shift function. The upper end of the lower hue shift function is equivalent to a lower end of the upper hue shift function.

In some aspects, the multi-segment brightness curve, an amount of the modifying saturation, and an amount of the shifting hue is dynamically updated on a per-scene basis.

In some examples a system, apparatus, and/or device includes a hardware processor and one or more computer-readable storage mediums having program instructions stored thereon to cause the hardware processor to perform operations as described within this disclosure.

In some examples, a computer program product includes one or more computer-readable storage mediums having program instructions stored thereon. The program instructions are executable by computer hardware to cause the computer hardware to initiate operations as described within this disclosure.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the implementations to only the examples shown. Various aspects and advantages will become apparent upon review of the following detailed description and upon reference to the drawings.

FIG. 1 illustrates an example architecture for processing standard dynamic range (SDR) content in accordance with the disclosed technology.

FIG. 2 illustrates an example of an S-shaped curve typically utilized to adjust brightness of frames using conventional global contrast enhancement techniques.

FIG. 3 illustrates an example of a multi-segment brightness curve as may be generated by a multi-segment brightness (MSB) curve generator.

FIG. 4 illustrates an example of saturation enhancing weights applied to SDR content by an adaptive saturation enhancer in accordance with the disclosed technology.

FIG. 5 illustrates an example of hue shift as implemented by an adaptive hue shifter.

FIG. 6 illustrates certain features of the disclosed technology relating to off-device operations and on-device operations.

FIG. 7 illustrates an example of the off-device operations illustrated in FIG. 6.

FIG. 8 illustrates another example architecture for processing SDR content in accordance with the disclosed technology.

FIG. 9 illustrates an example method of processing SDR content for display on a wide color gamut (WCG) high dynamic range (HDR) panel.

FIG. 10 illustrates an example of an HDR display capable of rendering SDR content in accordance with the disclosed technology.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to color enhancement of standard dynamic range (SDR) content for playing or rendering on a high dynamic range (HDR) panel. The disclosed technology provides methods, systems, and computer program products that are capable of enhancing color of SDR content as played on HDR panels in a manner that accounts for various factors such as cognitive factors of viewers in relation to the Human Vision System (HVS). The disclosed technology addresses visual quality degradation in SDR images as caused by the higher dynamic range of modern HDR panels and the wider color gamut available in most HDR panels.

Visual quality typically degrades when displaying narrow color gamut (NCG) SDR content on wide color gamut (WCG) HDR panels. Approaches such as simply stretching or scaling NCG colors to WCG colors for display on HDR panels often results in the display of images with distorted colors, including hue shifting, saturation distortions, etc. This can lead to visual fatigue in viewers and gives the content an “unreal” appearance and feel as perceived by viewers. Applying this approach to adapt highly saturated colors from a NCG to a WCG for display on WCG HDR panels often produces unnaturally saturated colors and can produce visual artifacts in the rendered images that may manifest as banding caused by the enlarged color distances between different segments of the images from the wide gamut stretching.

Colors of SDR content displayed on HDR panels also suffer from degradation in the colors as perceived by viewers owing to the high peak luminance of HDR panels. High peak luminance, as perceived by viewers, has the effect of de-saturating colors having relatively high brightness. Displaying SDR content on an HDR panel may significantly increase the brightness of shadow regions in the images thereby reducing or losing global contrast. Further, due to psychophysical effects of the HVS, changes in brightness may significantly change hue or saturation of the displayed SDR content as perceived by viewers. This changes the original visual effects and/or quality of the SDR content as displayed on the HDR panel. Colors of the SDR content may lose their vividness when directly rendered on WCG HDR panels.

The disclosed technology is capable of addressing the issues surrounding display of SDR content on HDR panels by accounting for brightness, saturation, and hue in combination with cognitive factors relating to the HVS to overcome or mitigate the unnaturalness of colors appearing in SDR content displayed on HDR panels. In some examples, the disclosed technology utilizes scene statistics for SDR content to be displayed on an HDR panel. The scene statistics may be generated from the SDR content in real-time or in substantially real-time. The brightness of pixels of images of SDR content may be rearranged based on a multi-segment brightness curve and the scene statistics. The multi-segment brightness curve may be generated from audience experience statistics that account for psychophysical effects and visual quality as perceived by the viewers.

The multi-segment brightness curve may include a plurality of different segments capable of mitigating brightness of pixels of images in a plurality of different regions of the images displayed. These regions may include, but are not limited to, a low tone dynamic range, a middle tone dynamic range, and a high tone dynamic range. In general, brightness of pixels may be rearranged or modified by decreasing brightness of pixels of the images in the low tone dynamic range, increasing brightness of pixels of the images in the middle tone dynamic range, and improving contrast of pixels of the images in the high tone dynamic range.

The disclosed technology is also capable of addressing issues relating to display of SDR content on an HDR panel by enhancing, e.g., adjusting, the saturation of one or more pixels of images of SDR content based on sensitivity of hue of the one or more pixels to stimulus. In addition, the hue of one or more pixels of the images of the SDR content may be shifted to different hues based on the audience experience statistics and the scene statistics of the SDR content.

The particular rearrangements/modifications of brightness, saturation enhancements, and/or hue shift(s) may be dynamically updated in real-time or in substantially real time while rendering SDR content on a per-scene basis. This allows the disclosed technology to provide a more natural viewing experience for viewers that adjusts or varies dynamically with the scene statistics of the SDR content being rendered on the HDR panel while also accounting for the viewer cognitive factors relating to the HVS.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

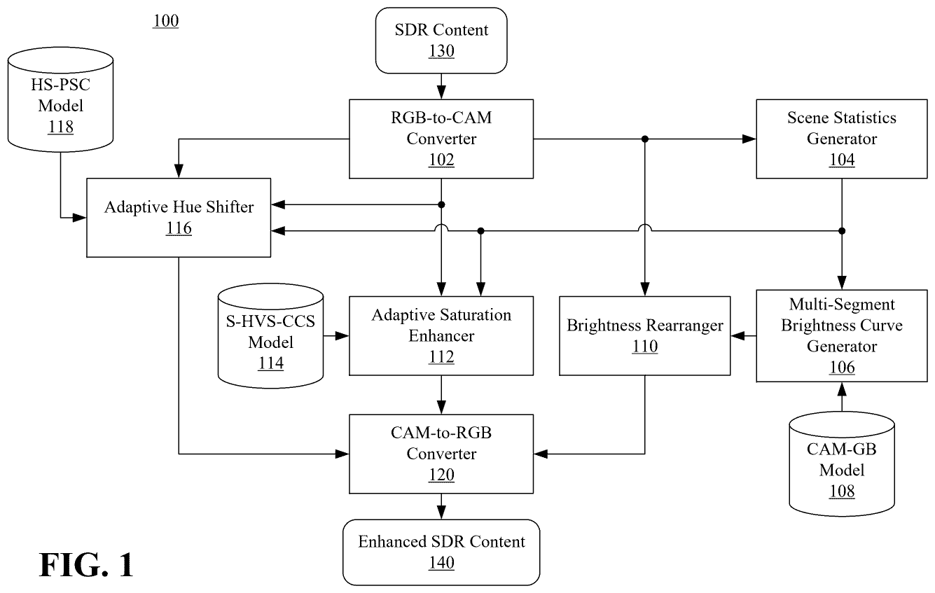

FIG. 1 illustrates an example architecture 100 for processing SDR content in accordance with the disclosed technology.

In one or more examples, architecture 100 is implemented as an executable architecture, e.g., program code, that may be executed by one or more hardware processors. The hardware processors may include, but are not limited to, central processing units (CPUs) and/or hardware accelerators of a data processing system. Examples of various types of hardware accelerators may include, but are not limited to, Application-Specific ICs (ASICs), programmable IC devices (e.g., field programmable gate arrays or “FPGAs”), graphics processing unit(s) (GPUs), digital signal processing units (DSPs), Neural Processing Units (NPUs), and/or Systems-on-Chip.

In one or more other examples, architecture 100 is implemented as an electronic system that may include a plurality of interconnected circuits as represented by the various blocks of FIG. 1, whether contained in a same integrated circuit (IC) device as an SoC or implemented in a plurality of interconnected IC devices. The IC device or devices, which may include hardware processors, may be configured to perform the various operations described herein. Examples of the IC device(s) may include, but are not limited to, ASICs, programmable IC devices (e.g., FPGAs), GPUs, DSPs, NPUs, SoCs, other hardware accelerators, and/or any combination of the foregoing.

In one or more examples, architecture 100 may be implemented as, or included within (e.g., embedded within), a device that includes, or is coupled to, an HDR panel and/or that plays SDR content on the HDR panel. The HDR panel may be a WCG display. Examples of such devices can include, but are not limited to, a computer (e.g., a workstation, a desktop computer, a mobile computer, a laptop computer, a netbook computer, a tablet computer), a television, an information appliance, a streaming device, or the like. In some examples, architecture 100 may be implemented, or included, within systems such as digital televisions (DTVs) or other content playback systems.

In the example, architecture 100 includes an RGB (red, green, blue)-to-CAM (Color Appearance Model) converter 102, a scene statistics generator 104, a multi-segment brightness curve generator 106, a CAM domain gamut boundaries (CAM-GB) model 108, a brightness rearranger 110, an adaptive saturation enhancer 112, a sensitivities of the HVS to changes in color stimulus (S-HVS-CCS) model 114, a hue shifting with perceptual smoothing constraints (HS-PSC) model 118, and a CAM-to-RGB converter 120.

In the example of FIG. 1, RGB-to-CAM converter 102 is capable of receiving SDR content 130 (e.g., one or more frames, e.g., digital images forming the SDR content 130). SDR content 130 also may have a NCG. In general, RGB-to-CAM converter 102 is capable of performing several operations on SDR content 130. These operations may include, but are not limited to, converting SDR content 130 to different formats and/or models and generating values for saturation (S) and hue (H) for SDR content 130.

In the example, SDR content 130 may be received by architecture 100 as input. SDR content 130 may include a plurality of frames (e.g., digital images). SDR content 130 is specified or formatted in the RGB color format or model. In the RGB format, SDR content 130 is generally represented as RGB code values. In order to address color of SDR content 130 as discussed, SDR content 130 is converted from the RGB format into another format that considers brightness (B), hue (H), and saturation (S) as different and separate quantities.

In the example, a CAM may be used to represent SDR content 130 since a CAM is capable of representing brightness, hue, and saturation separately. In some examples, the CIE-Lab model, which is a variety of CAM, may be used. Accordingly, RGB-to-CAM converter 102 is capable of converting SDR content 130, e.g., images from the RGB model or space into the CIE-LCH space. The CIE-LCH space is a device-independent color space defined by the International Commission on Illumination (CIE). The CIE-LCH space is designed to model human vision based on experimental data relating to how the human eye perceives color. RGB-to-CAM converter 102 is capable of converting SDR content 130 into the CIE-XYZ color space and then further convert SDR content 130 from the CIE-XYZ color space to CIE-LCH representations.

CIE-LCH representations may be derived from the CIE-XYZ color space representations of SDR content. CIE-LCH representations represent a perceptually uniform color space. The CIE-LCH representations generally transform the XYZ components into L*, a*, and b* where L* represents lightness, which is similar or analogous to brightness, a* representing the green-red axis, and b* representing the blue-yellow axis. L*, a*, and b* may be obtained by RGB-to-CAM converter 102 using Expressions 1 below.

$${L}^{*} = 1 \; 16 f ( \frac{Y}{{Y}_{n}} ) - 16 , \qquad ( 1 )$$

$${a}^{*} = 500 ( f ( \frac{X}{{X}_{n}} ) - f ( \frac{Y}{{Y}_{n}} ) ) ,$$

$${b}^{*} = 200 ( f ( \frac{Y}{{Y}_{n}} ) - f ( \frac{Z}{{Z}_{n}} ) )$$

In expressions 1, the conditions in Expression 2 are observed.

$$f ( t ) = \{ \begin{matrix}\sqrt[3]{t} , & if t > {δ}^{3} \\ \frac{1}{3} t {δ}^{- 2} + \frac{4}{29} & otherwise\end{matrix} \qquad ( 2 )$$

$$δ = \frac{6}{29}$$

From the CIE-La*b* representations, RGB-to-CAM converter 102 is further capable of generating CIE-LCH components, where hue (denoted as H) and chroma (saturation, denoted as S) are calculated in Expression 3 below. The chroma component of CIE-LCH color may be used to represent, or as a proxy of, saturation.

$$\{ \begin{matrix}H = a tan ( \frac{b}{a} ) \\ S = \sqrt{{a}^{2} + {b}^{2}}\end{matrix} \qquad ( 3 )$$

The example of Expression 3 uses the cylindrical representations of CIE-Lab called the CIE-LCH model to represent H and S.

Scene statistics generator 104 is capable of generating scene statics for SDR content based on the converted representations of SDR content 130 obtained from RGB-to-CAM converter 102. Scene statistics generator 104 is capable of generating various statistics describing SDR content on a per scene basis. In some examples, a scene refers to a narrative unit of a story and may be defined by actions occurring in a single location and/or time in SDR content 130. Scenes may have different numbers of frames. In some examples, scene statistics generator 104 is capable of generating scene statistics on a per frame basis.

Examples of scene statistics that may be generated by scene statistics generator 104 may include, but are not limited to, brightness statistics of pixels (e.g., a histogram) of pixels in a scene of SDR content 130 to be processed. Further examples of scene statistics with respect to saturation may include, but are not limited to, the lowest possible and the highest possible saturation in the saturation range of the scene of SDR content 130 to be processed. Further examples of scene statistics with respect to hue may include, but are not limited to, the lower and upper ranges of the different hues existing within the scene of HDR content that may be shifted.

Multi-segment brightness (MSB) curve generator 106 is capable of generating a multi-segment brightness curve that is used to adjust the brightness of one or more pixels of SDR content 130. In the example, MSB curve generator 106 is capable of accessing CAM-GB model 108. CAM-GB Model 108 models the CAM domain and, in particular, color gamut boundaries (GB). That is, CAM-GB model 108 is capable of defining the boundaries between different color gamuts in the CAM domain. MSB curve generator 106 generates a multi-segment brightness curve to adjust brightness based on CAM-GB model 108 and the scene relating to brightness received from scene statistics generator 104. The multi-segment brightness curve(s) generated by MSB curve generator 106 are provided to perceptual rearranger 110. MSB curve generator 106 is capable of generating a multi-segment brightness curve on a per scene basis. As noted, in some cases a scene may include a few as a single frame.

As discussed, directly displaying SDR content on an HDR panel without changing the brightness distributions may lead to multiple color degradations including, but not limited to, loss of contrast due to unnatural brightness lifting in shadow regions, provide limited room for increased saturated color recreation due to gamut shrinking in the high tone dynamic range, and/or perceptual hue shifting due to the high peak luminance of HDR panels. Perceptual rearranger 110 is capable of adjusting or modifying brightness of pixels in SDR content 130 based on the multi-segment brightness curve received from MSB curve generator 106. That is, perceptual rearranger 110 is capable of adjusting the brightness distribution of SDR content 130 based on the multi-segment brightness curve generated by MSB curve generator 106.

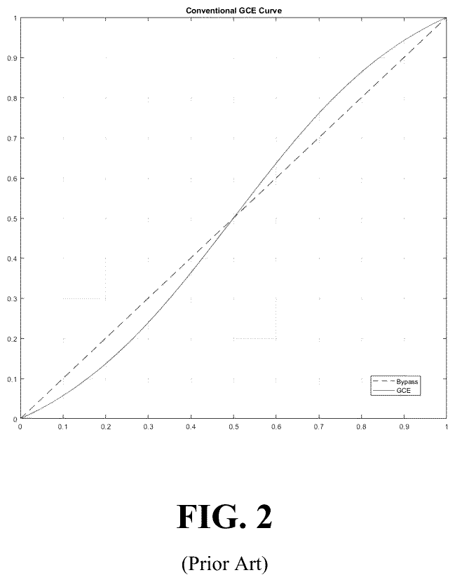

FIG. 2 illustrates an example of an S-shaped curve typically utilized to adjust brightness of frames using a conventional GCE technique. In the example of FIG. 2, it may be observed that while shadow regions may be protected (e.g., the left and lower portion of the curve), conventional GCE makes high tone distributions even higher, which exacerbates the existing issues relating to the limited room available for obtaining more saturated colors and perceptual hue shift. Based on FIG. 2, it also may be observed that conventional GCE compresses the high tone dynamic range (e.g., the right and upper portion of the curve), which may damage or degrade some fine details in very bright regions of frames.

Contrast maintenance and/or enhancement is an important aspect of rendering SDR content on HDR panels. GCE is an economic and effective technique for dealing with contrast maintenance and/or enhancement considering costs and the conveniences of hardware implementations. Conventional GCE, however, while generally suitable to enhance contrast of content for display on a same type of display, e.g., an SDR and/or NCG display, is not suitable for adapting SDR content for display on HDR panels. Such is the case as conventional CGE generally employs an S-shaped curve that makes bright regions brighter and dark regions darker.

The disclosed technology generates a hybrid brightness projection curve in the form of the multi-segment brightness curve which mitigates and/or solves such color degradation issues such as loss of contrast due to unnatural brightness lifting in shadow regions, limited room for increased saturated color recreation due to gamut shrinking in the high tone dynamic range, and perceptual hue shifting due to the high peak luminance of HDR panels. In some examples, the multi-segment brightness curve is based on subjective measurements of psychophysical effects of the HVS, e.g., audience metrics.

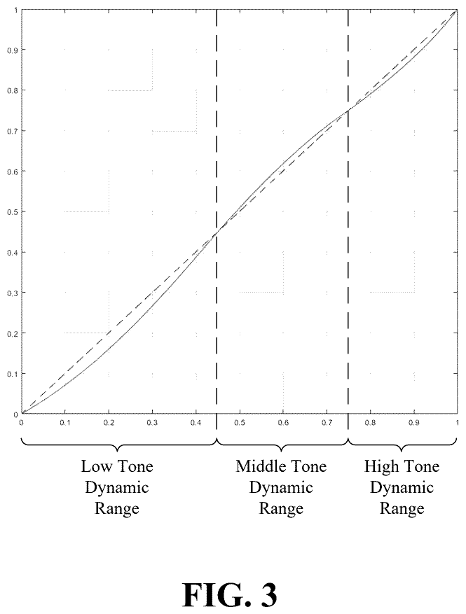

FIG. 3 illustrates an example of a multi-segment brightness curve as may be generated by MSB curve generator 106. In the example of FIG. 3, the multi-segment brightness curve is similar to the example of FIG. 2 at least with respect to pixels of frames having a brightness the low tone dynamic range. The multi-segment brightness curve effectively decreases brightness of pixels of frames in the low tone dynamic range. The multi-segment brightness curve inflects for pixels of the frames in the middle tone dynamic range. The multi-segment brightness curve effectively increases the brightness of pixels of the frames in the middle tone dynamic range. The multi-segment brightness curve inflects again for pixels of frames in the high tone dynamic range. The multi-segment brightness curve effectively increases the contrast of pixels of the frames in the high tone dynamic range by adopting a steeper curve.

The Hunt-Stevens effect indicates that perceived colorfulness by viewers increases with illuminance. Although pixels in displays such as television panels emit light, in the middle tone dynamic range, as brightness increases, the pixels also become brighter. This is similar to the situation in which the pixels do not emit light but rather reflect light with absorbing coefficients. As illuminance increases for pixels in the middle tone dynamic range, the colorfulness of the pixels can be perceptually increased based on the Hunt-Stevens effect. The disclosed technology, in reference to the multi-segment brightness curve, leverages the Hunt-Stevens effect to lift the brightness of pixels in the middle tone dynamic range. This increases the perceived colorfulness of the middle tone colors. Also, from the color solid of CAM, in reference to a 3-dimensional representation of all possible colors in a given color space, the color gamut is the widest in the middle tone dynamic range. By lifting the brightness of pixels in the middle tone dynamic range, the brightness of middle tone colors is increased without limiting the space for further saturation enhancement.

Because the color gamut shrinks in the high tone dynamic range, the multi-segment brightness curve decreases the brightness in this range. These adjustments leave more space to obtain more saturated and natural colors. By comparison, many unnaturally saturated colors are caused by out-of-gamut color clipping.

In some examples, the multi-segment brightness curve of FIG. 3 may be built according to Expression 4 below.

$$f ( x ) = \{ \begin{matrix}{f}_{l} ( x , α ) \text{:} α ∈ {R}_{l} \\ {f}_{m} ( x , β ) \text{:} β ∈ {R}_{m} \\ {f}_{h} ( x , γ ) \text{:} γ ∈ {R}_{h}\end{matrix} \qquad ( 4 )$$

In Expression 4, fₗ, fₘ, and fₕ are curve functions with different control parameters a, β, and γ, respectively. In Expression 4, x is the input brightness and R₁, Rₘ, and Rₕ are the dynamic ranges of low tone, middle tone, and high tone, respectively. To avoid brightness clipping caused by the respective segment functions, a condition, e.g., a loose condition, may be set or enforced at the connection points joining R₁, Rₘ, and Rₕ as given in Expression 5 below.

$${f}_{l} ( {x}_{c}^{1} ) = {f}_{m} ( {x}_{c}^{1} ) and {f}_{m} ( {x}_{c}^{2} ) = {f}_{h} ( {x}_{c}^{2} ) \qquad ( 5 )$$

In the example of Expression 5,

$${x}_{c}^{1}$$

is the connect point between Rₗ and Rₘ and

$${x}_{c}^{2}$$

is the connect point between Rₘ and Rₕ. In some examples, an S-shaped logistic function may be used for each of fₗ, fₘ, and fₕ. The S-shaped logistic function has high flexibility for adaptation to different curves. An example of an S-shaped logistic function that may be used for fₗ, fₘ, and fₕ is illustrated in Expression 6 below.

$$f ( x ) = A + \frac{K - A}{1 + {Qe}^{- bx}} \qquad ( 6 )$$

In Expression 6, K and A are horizontal asymptotes, Q is the cross-zero value, and b is the growth rate of the curve. With different values of b, different shapes of the curves may be obtained. From Expression 4, values of b in Expression 6 may be obtained for different multi-segment brightness projection curves. In generating fₕ, to suppress the high tone dynamic range, fₕ uses f⁻¹(x). The expressions for fₗ, fₘ, and fₕ may be implemented as Expression 6 with b_{α} used as the b values for fₗ, b_{β} used as the b values for fₘ, and b_{γ} used as the b values for fₕ. This allows the b values to be determined according to different purposes corresponding to the different segments.

For example, the value b_{α} may be determined to protect shadows. The value of b_{α} may be determined based on subjective evaluations of multiple SDR contents being rendered on HDR panels. In general, when an HDR panel has a high peak luminance, the value of b_{α} is also relatively high. The value b_{β} may be determined to improve perceptual colorfulness of colors based on the HVS and Hunt-Stevens effect. The value of b_{β} should not be so high so that pixels in the middle tone dynamic range are lifted to the high tone dynamic range. The value b_{γ} may be determined for both emphasizing details in the high tone dynamic range and increasing the saturation enhancing space in the high tone dynamic range. To obtain enough saturation enhancing space, the value b_{γ} can be larger, e.g., larger than the value of b_{β}. Using values for b_{γ} that are too large may lead to clipping artifacts and dimmed brighter regions that may generate high vision impact. Based on subjective evaluations, however, the value b_{γ} may be set relatively low.

Given the foregoing, fₗ may be implemented using Expression 6 with the parameter b_{α} as the growth rate tuned to protect shadow regions (e.g., the low tone dynamic range). fₘ may be implemented using Expression 6 with the parameter b_{β} as the growth rate tuned to lift brightness for the middle tone dynamic range leveraging the Hunt-Stevens effect. fₕ may be implemented using Expression 6 with the parameter b_{γ} as the growth rate tuned to suppress brightness in the high tone dynamic range leaving room for saturation.

Referring again to the example of FIG. 1, brightness rearranger 110 is capable of rearranging the brightness distribution, e.g., modifying the brightness of pixels of frames of SDR content 130, based on the multi-segment brightness curve. It should be appreciated that different HDR panels from different manufacturers may require different values of b_{α}, b_{β}, and b_{γ}. Further, since the Hunt-Stevens effect is a psychophysical aspect of the HVS, perception of the effect may be highly subjective and be perceived or manifest differently on different HDR panels. In this regard, in determining the values of b to be used, subjective visual quality evaluations from different viewers or audiences may be used to generate a set of optimized or usable values. The adjustments to brightness of pixels may be performed on a per-scene basis based on scene-specific multi-segment brightness curves.

For more robust color enhancing to different real-world contents, the disclosed technology can adopt scene-adaptive operators to make enhancing processing more effective to different scenes. An example of this strategy is that the disclosed technology adopts scene statistics to determine the range of the high tone dynamic range, the medium tone dynamic range, and the low tone dynamic range in the valid dynamic range of a HDR displayer, namely, dynamic range segmentation (DRS).

The disclosed technology is operative to adopt different perceptual adjusting curves through the entire dynamic range to obtain visually pleasing contrast and vivid colors. Directly using the entire valid dynamic range may not provide high quality results since there are many very dark or very bright scenes in real-world SDR content. The segments of the high tone dynamic range, the medium tone dynamic range, and the low tone dynamic range of an HDR displayer should not be constants. They are adaptive to different SDR content. Using percentiles of luminance of scenes is an effective way to adaptively determine the dynamic range segments. Example dynamic range segments may be specified (e.g., experimentally determined) by a set of given percentages. Example experimental results show that 5 percentages may provide good visual quality, including 5%, 50%, 70%, 90%, and 99.98%. The various examples described herein are provided for purposes of illustration and not limitation. In some other examples, a larger number of dynamic ranges, e.g., greater than three pertaining to low, middle, and high, may be used to provide increased image quality.

Adaptive saturation enhancer 112 is capable of enhancing saturation of pixels in SDR content 130 based on sensitivities of the HVS to changes in color stimulus. The HVS has different sensitivities to changes of different hues. For example, the HVS is very sensitive to changes in the hue of blue or red. In processing hues of blue and/or red, smaller adjustments (e.g., smaller scaling) may provide significant saturation enhancing effects. For other hues such as green, to which the HVS is less sensitive to changes, larger adjustments (e.g., larger scaling) may be used to obtain changes that are visually perceptible to viewers.

Conventional saturation adjustment techniques attempt to enhance color saturation by enhancing the S component with a scaling function where the scale is bigger than 1.0. Use of such scaling functions often leads to over-saturation issues when the input saturation of SDR content 130 is already large. This approach to enhancing saturation does not account for the properties of the HVS.

Adaptive saturation enhancer 112 is capable of enhancing saturation adaptively based on hue and the sensitivities of the HVS to different color stimulus changes based on S-HVS-CCS model 114. As noted, S-HVS-CCS model 114 specifies particular sensitivities of the HVS to changes in color stimulus for different colors. These may be expressed as weights or factors used to adjust pixels of various hues. This provides a more natural and robust solution. As noted, the HVS may respond weakly, e.g., not perceive a significant change, to the changes of saturation in cases where saturation is already very low or very high. The HVS does tend to respond strongly to saturation adjustments when saturation is already in a medium or middle range. This property is well described by Expression 6.

Accordingly, adaptive saturation enhancer 112 is capable of modifying saturation of pixels using a hue-adaptive saturation enhancing technique that operates in a normalized domain given by Expression 7 below. In expression 7, Sᵢ is the saturation of a color having hue Hi. Adaptive saturation enhancer 112 may normalize Sᵢ using Expression 7 to obtain the normalized saturation

$${S}_{i}^{′} .$$

$${S}_{i}^{′} = \frac{{S}_{i} - {S}_{s}}{{S}_{T} - {S}_{s}} \qquad ( 7 )$$

In Expression 7, S_{S} and S_{T} are the lowest possible and the highest possible saturation in the saturation range that is to be enhanced. In the example, S_{S} is effective to protect near white colors. In the normalized domain, Expression 6 may be expressed as Expression 8 below.

$$f ( x ) = - 1.0623 + \frac{2.1246}{1 + {e}^{- bx}} \qquad ( 8 )$$

Adaptive saturation enhancer 112 is capable of comparing the enhanced saturation, denoted as

$${S}_{o}^{′} ,$$

with the result from Expression 8. Adaptive saturation enhancer 112 may calculate the enhanced saturation

$${S}_{o}^{′}$$

based on the inverse of Expression 7. Adaptive saturation enhancer 112 is capable of computing the final enhanced saturation while accounting for the properties of the HVS using Expression 9 below.

$${S}_{e} = {w}_{s} {S}_{o} + ( 1 - {w}_{s} ) {S}_{i} \qquad ( 9 )$$

Within Expression 9, wₛ may be expressed as a weight in the range of [0, 1]. The weight wₛ may be generated through experimentation accounting for the HVS. For example, the weight may be generated using an experimentally determined function derived based on the sensitivities of HVS to the changes of color stimulus. The weight calculation function is flexible.

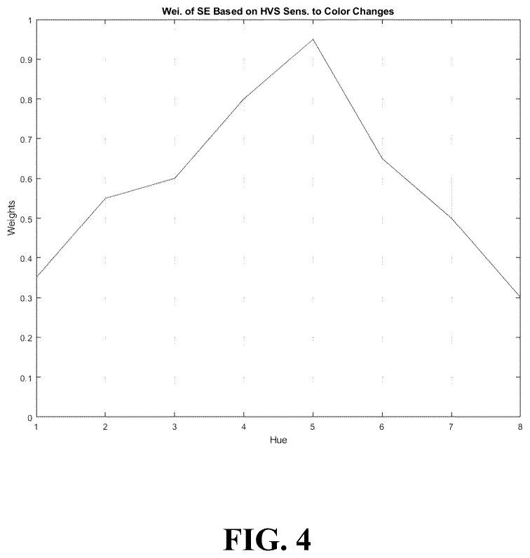

FIG. 4 illustrates an example of saturation enhancing weights specified by S-HVS-CCS model 114 and applied to SDR content 130 by adaptive saturation enhancer 112 in accordance with the disclosed technology. The weights illustrated in FIG. 4 along the Y-axis for the hues illustrated along the X-axis may be used to adjust the brightness of pixels in a manner that accounts for sensitivities of the HVS to different color stimulus changes for different hues. In other words, the weights illustrated in FIG. 4 account for sensitivities of viewers, owing to the HVS, to changes in colors.

In the example of FIG. 4, it may be observed that adaptive saturation enhancer 112 applies relatively low weights (e.g., makes smaller adjustments) to brightness for the hues to which HVS has relatively high sensitivities to stimulus changes (e.g., blue tones and/or red tones). Adaptive saturation enhancer 112 applies relatively high weights (e.g., makes larger adjustments) to brightness for the hue(s) to which HVS has relatively low sensitivities to stimulus changes (e.g., green tones).

Turning again to FIG. 1, adaptive hue shifter 116 is capable of shifting hue(s) of SDR content 130 to compensate for perceptual hue distortion that arises from the high peak luminance of HDR panels. When displaying SDR content 130 on HDR panels that have a high peak luminance, perceptual hue may have visible distortions due to several psychophysical effects of the HVS. Adaptive hue shifter 116 is capable of applying controllable hue shift(s) specified by HS-PSC model 118 to pixels to compensate for the hue distortions thereby restoring vivid colors.

Adaptive hue shifter 116, in applying appropriate hue shifting, helps to generate natural and significant saturation enhancing effects without introducing unnatural distortions. Based on audience experience statistics, appropriately shifting cyan to blue in big regions of SDR content 130, e.g., the sky, significantly increased visual pleasure of audiences. For example, audiences felt that the sky was effectively enhanced when the adjustment shifted cyan tones toward blue. The effect is also related to the psychophysical properties of the HVS. Again, based on audience experience statistics, hue shift may be implemented to obtain perceptually more saturated and more visually pleasing colors without apply high-gain saturation enhancement to SDR content 130. This approach, as implemented by 116, is able to avoid unnatural or visually oversaturated colors on high peak luminance HDR panels.

The high brightness of HDR panels may significantly change perceptual hue and saturation of SDR colors which look natural and vivid on SDR displays. Due to the Abney effect of the HVS, as the brightness of SDR colors increase on HDR panels, which is similar to adding more white to colors, perceptual hue shifts. For example, red tones shift toward magenta, green tones shift toward cyan, and blue tones shift toward purple. Due to the Bezold-Bruck effect of the HVS, as brightness of SDR colors becomes higher on HDR panels, short wavelength colors start to shift towards blue, and long wavelength colors start to shift towards yellow. Perceptually yellowish red tones may decrease their vividness. Adaptive hue shifter 116 is capable of mitigating or addressing these color degradations.

Adaptive hue shifter 116 is capable of shifting hue of SDR content 130 using one or more hue shifting techniques. The hue shifting technique(s) employed by adaptive hue shifter 116 may be determined or derived based on audience experience statistics and/or specified by HS-PSC model 118. Each hue shifting technique is capable of compensating for color-degradation caused by the psychophysical effects of the HVS and aids color saturation enhancing effects. Adaptive hue shifter 116 is able to perform one or more or any combination of the following hue shifting techniques:

Adaptive hue shifter 116 is capable of shifting pixels of cyan to blue. This technique may significantly improve the vividness.

Adaptive hue shifter 116 is capable of shifting pixels of yellow-green tones to green. This technique increases “cooling” effects and produces more vivid colors in all greenish tones.

Adaptive hue shifter 116 is capable of shifting pixels of orange-red tones toward red. This technique effectively compensates for the yellowish-red caused by the Bezold-Bruck effect to produce vivid red colors.

Adaptive hue shifter 116 is capable of shifting pixels of purple-red tones toward red. This technique effectively improves the vividness-loss issue of red tones caused by the Abney effect.

While the use of hue shifting in frames based on audience experience data can improve vividness of SDR colors as displayed on HDR panels, in some cases, such hue shifting may introduce contour artifacts in the resulting frames. To avoid such artifacts, moving pixels of a particular hue also requires that the neighbor pixels also shift accordingly or in like manner. Otherwise, the pixels with shifted hue may lead to discontinuities in previously continuous regions of hue. Adaptive hue shifter 116 utilizes a hue shift strategy with respect to the various techniques described that also provides perceptual hue smoothness to address contour artifacts. Expression 10 below illustrates an example of a hue shift strategy that may be implemented by adaptive hue shifter 116. Within Expression 10, H_{L} and H_{U} represent the lower and upper hue, respectively, of a hue range in which hue is to be shifted. For adaptive hue shifter 116 to shift hue smoothly, a hue shift function, denoted fₕ(.), must satisfy the condition in Expression 10 below.

$$\{ \begin{matrix}{f}_{h} ( {H}_{L} ) = {H}_{L} \\ {f}_{h} ( {H}_{U} ) = {H}_{U} \\ {f}_{h} ( {H}^{-} ) = {f}_{h} ( {H}^{+} )\end{matrix} \qquad ( 10 )$$

The condition of Expression 10, i.e., fₕ(H⁻)=fₕ(H⁺), requires that changes in a given hue in the range [H_{L}, H_{U}] will be smooth without any jumping or discontinuity. The logistic function illustrated in Expression 6 may be used as an example implementation to perform a hue shifting operation in the normalized domain. A given hue may be normalized in accordance with Expression 11 below.

$${H}^{′} = \frac{H - {H}_{L}}{{H}_{U} - {H}_{L}} \qquad ( 11 )$$

By normalizing a given hue, H_{L} becomes 0 and H_{U} becomes 1. Adaptive hue shifter 116 may use Expression 8 to calculate the shifted and normalized hue without changing the range limit hue.

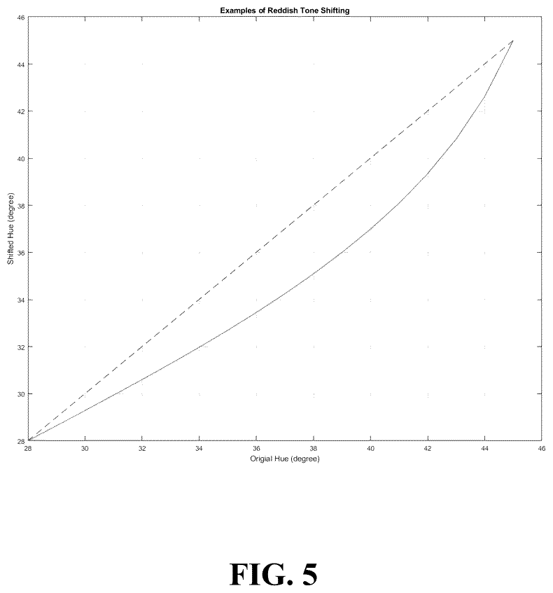

FIG. 5 illustrates an example of hue shift as implemented by adaptive hue shifter 116. More particularly, FIG. 5 illustrates an example of reddish tone hue shift implemented by adaptive hue shifter 116 using the perceptual smoothness orientated hue shifting techniques described herein. As discussed, the reddish tones in SDR content 130 may perceptually become yellowish due to the Bezold-Bruck effect of the HVS when displayed on an HDR panel. Audience experience statistics show that slightly shifting reddish tones can effectively improve the vividness of the colors. The shift may be approximately 3 to 5 degrees.

In FIG. 5, the original hue is illustrated in degrees along the X-axis and the shifted hue is illustrated in degrees along the Y-axis. In the example, when input hue values are close to the limit hue (e.g., 28 and 45), the shift in hue is very small. Moving along the X-axis from the lower limit hue to the upper limit hue, other degrees of hue are gradually shifted with the shift offsets changing from small to big and then small again. In implementing this approach, e.g., shifting hue in approximately the amounts illustrated while observing the constraints of Expression 10, adaptive hue shifter 116 is capable of shifting hue in a manner that guarantees smoothness. This also provides smoothness in transitions from one hue to the next.

Turning again to FIG. 1, the resulting components from each of perceptual rearranger 110, adaptive saturation enhancer 112, and adaptive hue shifter 116 are provided to CAM-to-RGB converter 120 and transform the SDR content back into the RGB format as enhanced SDR content 140. Enhanced SDR content 140 may then be displayed on an HDR display with significantly enhanced color quality.

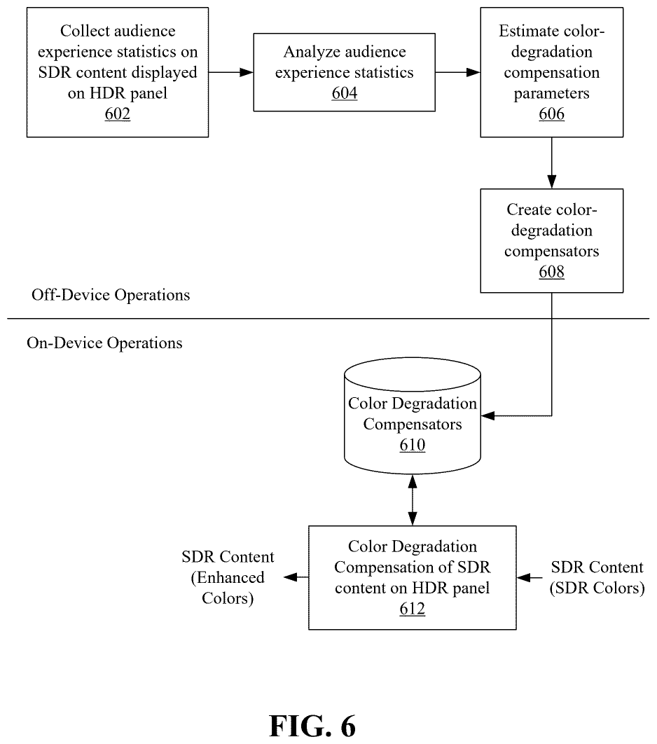

FIG. 6 illustrates certain features of the disclosed technology relating to off-device operations and on-device operations. The example of FIG. 6 provides an overview of the disclosed technology. Aspects of FIG. 6 illustrate both off-device and on-device operations. The example of FIG. 6 illustrates a plurality of off-device operations that tend to be computationally expensive and on-device operations that lend themselves to hardware-friendly implementations. As illustrated, those operations or tasks that may require manual implementation that tend to be time-consuming and relate to the collection and/or processing of audience experience statistics may be performed off-device.

For example, block 602 illustrates that the collection of audience experience statistics for SDR content displayed on HDR panels may be performed off-device as a manual process. Analysis of audience experience statistics 604 may be performed off-device as a manual process. Estimating color-degradation compensation parameters 606, e.g., the various models illustrated in FIG. 1, may be performed off-device as manual processes. In addition, the creation of color-degradation compensators 608, e.g., the various curves and/or correction amounts to be applied, which is a computationally expensive process, though not a manual process, may also performed off-device. This separation of processes allows the color degradation compensation techniques to be implemented with lower hardware cost (e.g., may be executed/implemented using less powerful hardware).

Creation of color-degradation compensators 608 creates a plurality, e.g., a bank, of color degradation compensators 610 that may be stored or buffered in memory on-device. The color degradation compensation 612 of SDR content to be displayed on HDR panels are light duty operations that may be efficiently performed on SDR content in-device. These operations may be performed with relatively low hardware costs.

The computations necessary to perform scene-adaptive cognitive color enhancing based on psychophysical effects of the HVS are relatively complex. Directly carrying out these computations within products, e.g., on the HDR device displaying the SDR content, is costly in terms of computational power and price.

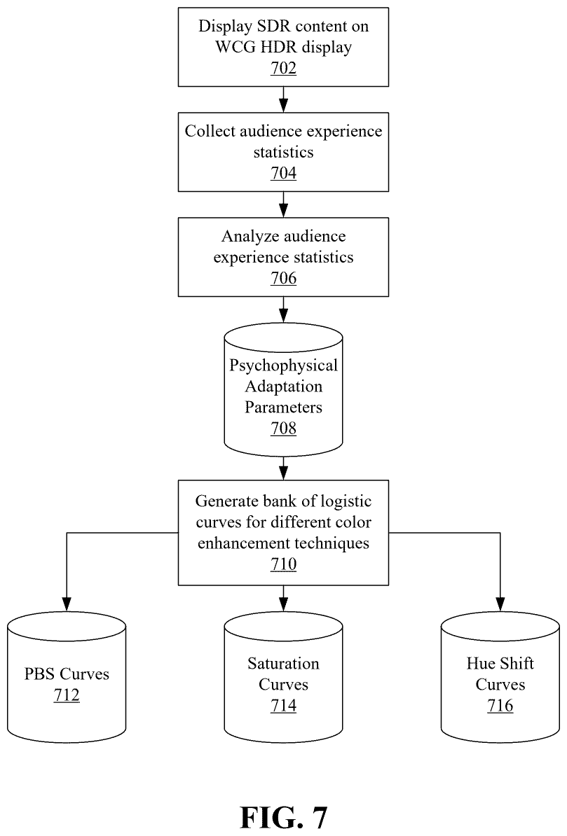

FIG. 7 illustrates another example of the off-device processing illustrated in FIG. 6. As noted, the off-device processing includes those operations with greater computational complexity such that hardware costs are not a concern or are much less of a concern than if performed on-device.

In block 702, SDR content is displayed on a WCG HDR display to viewers (e.g., an audience). In block 704, audience experience statistics are collected from viewers watching the SDR content displayed on the WCG HDR display. In block 706, the audience experience statistics are analyzed. In block 706, features of color differences of SDR colors as displayed on the WCG HDR, as perceived by the viewers, are detected or identified. Data analysis of block 706 generates a data set of psychophysical adaptation parameters 708 (e.g., the estimation of color-degradation compensation parameters). The psychophysical adaptation parameters 708 provide block 710 with appropriate parameters for generating the respective curves for the different color enhancement techniques described herein.

In block 710, a bank of logistic curves for the different color enhancement techniques are generated. As illustrated, in block 710, perceptual brightness segmented (PBS) curves 712 as illustrated in FIG. 3, saturation curves 714 as illustrated in FIG. 4, and hue shift curves 716 as illustrated in FIG. 5 are generated.

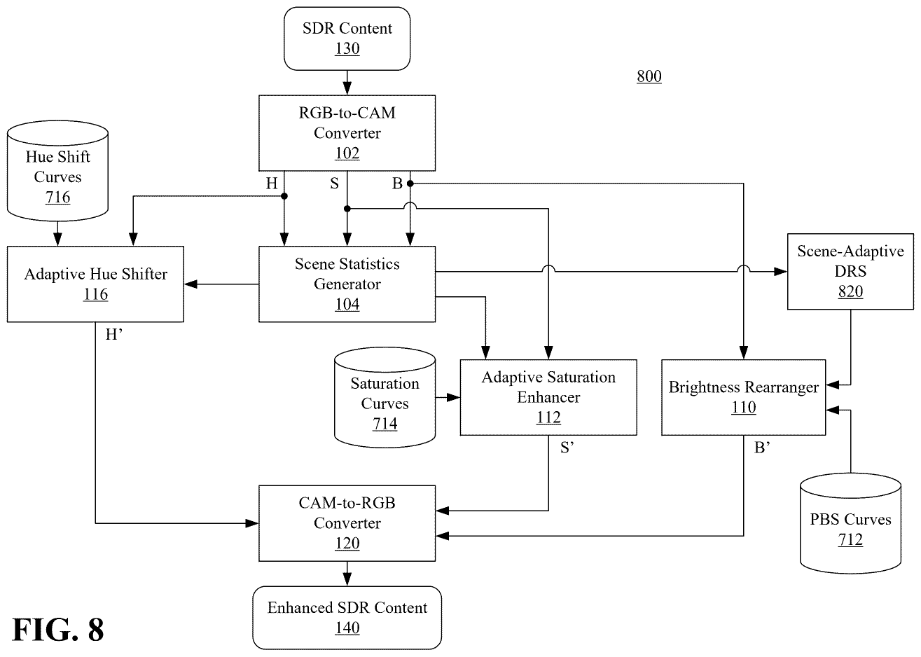

FIG. 8 illustrates another example architecture 800 for processing SDR content in accordance with the disclosed technology. The example of FIG. 8 illustrates an efficient hardware implementation capable of performing the color enhancement operations described herein. In the example of FIG. 8, certain operations illustrated in FIG. 1 may be implemented off-device as discussed in connection with FIGS. 6 and 7. Accordingly, like named blocks between FIGS. 1 and 8 may be adapted to work in the lightweight, hardware-oriented, in-device context illustrated in FIG. 8.

In one or more examples, architecture 800 is implemented as an executable architecture, e.g., program code, that may be executed by one or more hardware processors. The hardware processors may include, but are not limited to, CPUs and/or hardware accelerators of a data processing system. Examples of various types of hardware accelerators may include, but are not limited to, ASICs, programmable IC devices (e.g., FPGAs), GPUs, DSPs, NPUs, and/or SoCs.

In one or more other examples, architecture 800 is implemented as an electronic system that may include a plurality of interconnected circuits as represented by the various blocks of FIG. 1, whether contained in a same IC device as an SoC or implemented in a plurality of interconnected IC devices. The IC device or devices, which may include hardware processors, may be configured to perform the various operations described herein. Examples of the IC device(s) may include, but are not limited to, ASICs, programmable IC devices (e.g., FPGAs), GPUs, DSPs, NPUs, SoCs, other hardware accelerators, and/or any combination of the foregoing.

As discussed in connection with architecture 100 of FIG. 1, in one or more examples, architecture 800 may be implemented as, or included within (e.g., embedded within), a device that includes, or is coupled to, an HDR panel and/or that play SDR content on the HDR panel. The HDR panel may be a WCG display. Examples of such devices can include, but are not limited to, a computer (e.g., a workstation, a desktop computer, a mobile computer, a laptop computer, a netbook computer, a tablet computer), a television, an information appliance, a streaming device, or the like. In some examples, architecture 800 may be implemented, or included, within systems such as digital televisions (DTVs) or other content playback systems.

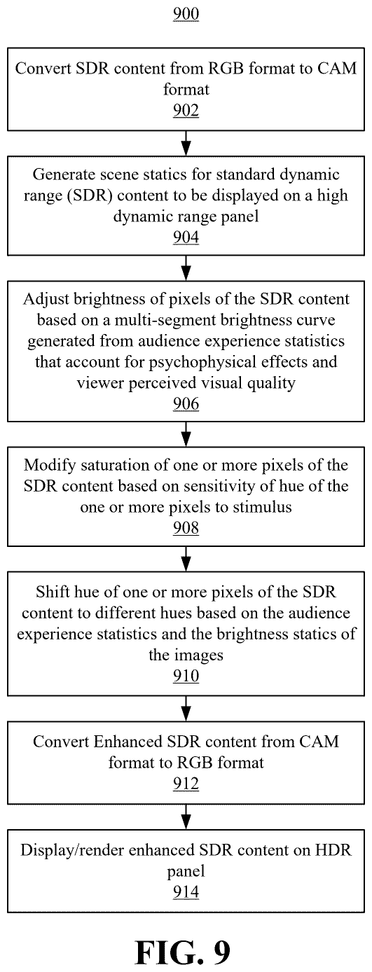

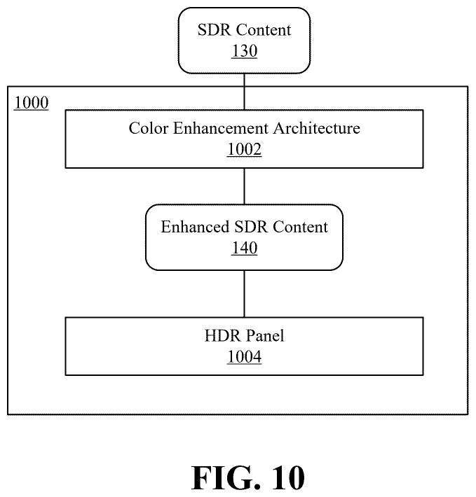

FIG. 9 illustrates an example method 900 of processing SDR content for display on a wide color gamut (WCG) high dynamic range (HDR) panel. Referring to FIGS. 9 and 10 in combination, in block 902, RGB-to-CAM converter 102 receives SDR content 130 and converts the SDR content from RGB format into a CAM format. As illustrated, RGB-to-CAM converter 102 is capable of outing hue (H), saturation (S), and brightness (B) data for pixels of each scene of SDR content 130. In the example, hue, saturation, and brightness data are output to scene statistics generator 104. Brightness data is also output to brightness rearranger 110 which may be configured to rearrange the brightness distribution of pixels of scenes of SDR content 130. Saturation data is also output to adaptive saturation enhancer 112. Hue data is also output to adaptive hue shifter 116, which is capable of performing perceptual hue shifting.

In the example, the various curves that are stored, or buffered, within architecture 800 may be stored in the respective data stores, e.g., memory, as digital representations of the curves. For example, the curve data for perceptual brightness segmented (PBS) curves 712, saturation curves 714, and hue shift curves 716 may be stored as lookup tables that may be accessed by perceptual rearranger 110, adaptive saturation enhancer 112, and adaptive hue shifter 116, respectively.

In block 904, scene statistics generator 104 is capable of generating scene statics for SDR content 130 to be displayed on an HDR panel. For example, scene statistics generator 104 is capable of generating scene statistics that may include, but are not limited to, brightness statistics of pixels (e.g., a histogram) of pixels in a scene, saturation statistics such as the lowest possible and the highest possible saturation in the saturation range of the scene of SDR content 130, and/or hue statistics such as the lower and upper ranges of the different hues in the scene of SDR content 130 that may be shifted.

In the example, scene-adaptive dynamic range segmenter (DRS) 820 is capable of detecting the range for each of the high tone dynamic range, the middle tone dynamic range, and the low tone dynamic range based on the scene statistics output from the scene statistics generator 104. In this regard, the boundaries for each of the high tone dynamic range, the middle tone dynamic range, and the low tone dynamic range for SDR content 130 will change or differ for each scene based on the scene statistics received from scene statistics generator 104 for that scene. Scene-adaptive DRS 820 is capable of outputting the range for each of the high tone dynamic range, the middle tone dynamic range, and the low tone dynamic range to perceptual rearranger 110.

In block 906, perceptual rearranger 110 is capable of adjusting brightness of pixels of the SDR content 130 based on a multi-segment brightness curve generated from audience experience statistics that account for psychophysical effects and viewer perceived visual quality. Brightness rearranger 110 is capable of adjusting the brightness of pixels using particular ones of the PBS curves 712 selected based on the respective ranges received from scene-adaptive DRS 820. Those pixels having a brightness (B) in the high tone dynamic range are adjusted using the high tone segment of the selected curve. Those pixels having a brightness in the middle tone dynamic range are adjusted using the middle tone segment of the selected curve. Those pixels having a brightness in the low tone dynamic range are adjusted using the low tone segment of the selected curve.

For example, perceptual rearranger 110 is capable of adjusting the brightness of pixels (e.g., the brightness distribution of the SDR content 130) by performing one or more or any combination of decreasing brightness of pixels of the SDR content in a low tone dynamic range, increasing brightness of pixels of the SDR content in a middle tone dynamic range, and/or decreasing brightness of pixels of the SDR content in a high tone dynamic range.

In block 908, adaptive saturation enhancer 112 is capable of modifying saturation of one or more pixels of SDR content 130 based on sensitivity of hue of the one or more pixels to stimulus. Adaptive saturation enhancer 112 is capable of adjusting the saturation of pixels in SDR content 130 using selected ones of the saturation curves 714 based on scene statistics from scene statistics generator 104. The scene statistics, for example, may specify information such as S_{S} and S_{T}, being the lowest possible and the highest possible saturation in the saturation range that is to be enhanced in Expression 7.

In some examples, adaptive saturation enhancer 112 is capable of enhancing saturation by increasing saturation of one or more pixels of a first hue having a first sensitivity, e.g., a high sensitivity, to stimulus using a first weight. For example, hues that have a high sensitivity to stimulus may be blue and/or red. Such hues may be adjusted using a low weight. Enhancing saturation may also include increasing saturation of one or more pixels of a second hue having a second sensitivity, e.g., a low sensitivity, to stimulus that is less than the first sensitivity using a second weight that exceeds the first weight. For example, a hue that has a low sensitivity to stimulus is green. Such a hue may be adjusted using a high weight, e.g., a weight that exceeds the weight used to adjust hues with high sensitivity to stimulus.

In block 910, adaptive hue shifter 116 is capable of shifting hue of one or more pixels of SDR content 130 to different hues based on the audience experience statistics and the brightness statics of the SDR content. Adaptive hue shifter 116 is capable of shifting the hue of pixels in SDR content using selected ones of the hue shift curves 716 based on scene statistics from scene statistics generator 104. The scene statistics, for example, may specify information such as H_{L} and H_{U} representing the lower and upper hue, respectively, of a hue range in which hue is to be shifted for purposes of normalizing the hue.

In some examples, shifting hue of one or more pixels of the SDR content may include one or more or any combination of the following operations: shifting one or more pixels of a first selected hue to a second selected hue based on the audience experience statistics. For example, pixels of cyan may be shifted to blue, pixels of yellow-green may be shifted to green, pixels of orange or orange-red may be shifted to red, and/or pixels of purple or purple-red may be shifted to red. The hue of pixels may be shifted based on a hue shift function. The hue shift function may include a lower hue shift function and an upper hue shift function. To ensure continuity as perceived by users in any hue shifts, the upper end of the lower hue shift function is equivalent to a lower end of the upper hue shift function.

With respect to enhancing saturation and/or shifting hue, such operations may be performed using one or more logistic curves that facilitate visual smoothness with respect to the quantities/features being modified so as to facilitate a natural experience by the viewers.

In block 912, CAM-to-RGB converter 120 is capable of converting enhanced hue (H′), enhanced saturation (S′) and enhanced brightness (B′) output from each of perceptual rearranger 110, adaptive saturation enhancer 112, and adaptive hue shifter 116 from the CAM format into RGB format resulting in enhanced SDR content 140. In block 914, the enhanced SDR content 140 may be displayed on an HDR (e.g., a WCG HDR) panel.

The in-device processing illustrated in the example of FIG. 8 involves computations that apply curves to the pixel data. Since the curves are generated from the dataset based on audience experience statistics, each curve is capable of compensating a particular color degradation caused by high peak luminance, wide-gamut colors of WGC HDR panels, and/or psychophysical effects of the HVS. In some examples, a one-dimensional lookup table may be used to represent the various complex curves described herein.

FIG. 10 illustrates an example of an HDR display 1000 capable of rendering SDR content in accordance with the disclosed technology. In the example, HDR display includes color enhancement architecture 1002. Color enhancement architecture 1002 is implemented as circuitry capable of implementing architecture 100 of FIG. 1 or architecture 800 of FIG. 8 to process SDR content 130 and output enhanced SDR content 140. As illustrated, enhanced SDR content 140 may be provided to an HDR panel 1004, that may display or render the enhanced SDR content 140 thereon.

The example of FIG. 10 may be illustrative of various use cases that may include displaying SDR content on an HDR television or enhancing content as displayed on various portable computing devices and/or mobile devices. FIG. 10 is also illustrative of enhancing SDR content on online streaming applications. In some examples, the color enhancing described herein may be performed with the results being output to a separate HDR panel that is coupled to the color enhancement architecture 1002 of FIG. 10.

The terminology used herein is for the purpose of describing particular examples only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, “data processing system” means one or more hardware systems configured to process data, each hardware system including at least one hardware processor programmed to initiate operations and memory.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being. A “viewer” also refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the term “real-time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc., may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the implementations described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the implementations described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the implementations described herein.

Certain aspects of the implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the implementations. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various implementations of the disclosed technology have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method, comprising:
generating scene statics for standard dynamic range (SDR) content to be displayed on a high dynamic range panel;
adjusting brightness of pixels of the SDR content based on a multi-segment brightness curve generated from audience experience statistics that account for psychophysical effects and viewer perceived visual quality;
modifying saturation of one or more pixels of the SDR content based on sensitivity of hue of the one or more pixels to stimulus; and
shifting hue of one or more pixels of the SDR content to different hues based on the audience experience statistics and the scene statics.

2. The method of claim 1, wherein the adjusting the brightness of pixels based on the multi-segment brightness curve includes:
decreasing brightness of pixels of the SDR content in a low tone dynamic range;
increasing brightness of pixels of the SDR content in a middle tone dynamic range; and
increasing perceptual contrast of pixels of the SDR content in a high tone dynamic range.

3. The method of claim 1, wherein the modifying saturation and the shifting hue are performed based on psychophysical effects of the human vision system using one or more logistic curves that provide visual smoothness.

4. The method of claim 1, wherein the modifying saturation comprises:
increasing saturation of one or more pixels of a first hue having a first sensitivity to stimulus using a first weight; and
increasing saturation of one or more pixels of a second hue having a second sensitivity to stimulus that is less than the first sensitivity using a second weight that exceeds the first weight.

5. The method of claim 4, wherein the first hue is at least one of blue or red and the second hue is green.

6. The method of claim 1, wherein the shifting hue of one or more pixels of the SDR content comprises:
shifting one or more pixels of a first selected hue to a second selected hue based on the audience experience statistics and psychophysical effects of the human vision system.

7. The method of claim 6, wherein the shifting hue one or more pixels of the first hue to the second hue include at least one of shifting one or more pixels of cyan to blue, shifting one or more pixels of yellow-green to green, shifting one or more pixels of orange or orange-red to red, shifting one or more pixels of purple or purple-red to red.

8. The method of claim 6, wherein the one or more pixels are shifted based on a hue shift function including a lower hue shift function and an upper hue shift function, wherein an upper end of the lower hue shift function is equivalent to a lower end of the upper hue shift function.

9. The method of claim 1, wherein the multi-segment brightness curve, an amount of the modifying saturation, and an amount of the shifting hue is dynamically updated on a per-scene basis.

10. A system, comprising:
one or more hardware processors;
one or more computer-readable storage mediums having program instructions stored thereon to cause the one or more hardware processors to perform operations comprising:
generating scene statics for standard dynamic range (SDR) content to be displayed on a high dynamic range panel;
adjusting brightness of pixels of the SDR content based on a multi-segment brightness curve generated from audience experience statistics that account for psychophysical effects and viewer perceived visual quality;
modifying saturation of one or more pixels of the SDR content based on sensitivity of hue of the one or more pixels to stimulus; and
shifting hue of one or more pixels of the SDR content to different hues based on the audience experience statistics and the scene statics.

11. The system of claim 10, wherein the adjusting the brightness of pixels based on the multi-segment brightness curve includes:
decreasing brightness of pixels of the SDR content in a low tone dynamic range;
increasing brightness of pixels of the SDR content in a middle tone dynamic range; and
increasing perceptual contrast of pixels of the SDR content in a high tone dynamic range.

12. The system of claim 10, wherein the modifying saturation and the shifting hue are performed based on psychophysical effects of the human vision system using one or more logistic curves that provide visual smoothness.

13. The system of claim 10, wherein the modifying saturation comprises:
increasing saturation of one or more pixels of a first hue having a first sensitivity to stimulus using a first weight; and
increasing saturation of one or more pixels of a second hue having a second sensitivity to stimulus that is less than the first sensitivity using a second weight that exceeds the first weight.

14. The system of claim 13, wherein the first hue is at least one of blue or red and the second hue is green.

15. The system of claim 10, wherein the shifting hue of one or more pixels of the SDR content comprises:
shifting one or more pixels of a first selected hue to a second selected hue based on the audience experience statistics and psychophysical effects of the human vision system.

16. The system of claim 15, wherein the shifting hue one or more pixels of the first hue to the second hue include at least one of shifting one or more pixels of cyan to blue, shifting one or more pixels of yellow-green to green, shifting one or more pixels of orange or orange-red to red, shifting one or more pixels of purple or purple-red to red.

17. The system of claim 15, wherein the one or more pixels are shifted based on a hue shift function including a lower hue shift function and an upper hue shift function, wherein an upper end of the lower hue shift function is equivalent to a lower end of the upper hue shift function.

18. The system of claim 10, wherein the multi-segment brightness curve, an amount of the modifying saturation, and an amount of the shifting hue is dynamically updated on a per-scene basis.

19. A computer program product, comprising:
one or more computer-readable storage mediums having program instructions stored thereon, wherein the program instructions are executable by computer hardware to cause the computer hardware to initiate operations comprising:
generating scene statics for standard dynamic range (SDR) content to be displayed on a high dynamic range panel;
adjusting brightness of pixels of the SDR content based on a multi-segment brightness curve generated from audience experience statistics that account for psychophysical effects and viewer perceived visual quality;
modifying saturation of one or more pixels of the SDR content based on sensitivity of hue of the one or more pixels to stimulus; and
shifting hue of one or more pixels of the SDR content to different hues based on the audience experience statistics and the scene statics.

20. The computer program product of claim 19, wherein the multi-segment brightness curve, an amount of the modifying saturation, and an amount of the shifting hue is dynamically updated on a per-scene basis.
